(19) United States
(12) Patent Application Publication
(10) Pub. No.: US 2008/0084792 A1
(43) Pub. Date: Apr. 10, 2008

(54) TIMEPIECE

(75) Inventors: Yoichi HAYASHI, Suwa (JP); Takaya MASAKI, Matsumoto (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 11/852,761

(22) Filed: Sep. 10, 2007

(30) Foreign Application Priority Data
Oct. 10, 2006 (JP) 2006-276156
Oct. 10, 2006 (JP) 2006-276157
Jul. 5, 2007 (JP) 2007-177196
Jul. 5, 2007 (JP) 2007-177197

(51) Int. Cl. G04B 19/06

(52) U.S. Cl. 368/80

(57) ABSTRACT

A timepiece according to a first aspect of the invention has a fan-shaped display unit including a display wheel that can rotate, a stepping motor that rotationally drives the display wheel in both forward and reverse directions, a reverse stop that limits reverse rotation of the display wheel, and an indication means that is attached to the display wheel; and a control unit that applies pulses to the stepping motor. The position of the reverse stop is set so that the orientation of one polar axis of the rotor of the stepping motor when the display wheel is stopped by the reverse stop at the reverse stop is within ±360°/(number of magnetic poles of rotor*2) from the static stable position of the polar axis. After stopping at the reverse stop, the polarity of the first pulse applied to the stepping motor by the control unit is constant.

### BACKGROUND

1. Field of Invention

The present invention relates to a timepiece, and relates more particularly to a timepiece that has a fan-shaped display unit.

2. Description of Related Art

The effects of powerful external magnetic fields on the stepping motor or strong shocks to the timepiece itself can cause the hands to shift from where the hands should be pointing in an electronic timepiece that uses a stepping motor to drive the hands to display information. If the user can readily tell visually that the hands are out of position, such as when the displayed content is the date, the time, or a chronograph, the user can immediately reset the hands. However, if the displayed content is internal timepiece information, such as the remaining battery capacity, there is no way for the user to compare the displayed information with the correct information that should be displayed, and the user may therefore not realize that the hands are incorrectly positioned. A function for detecting the internal timepiece information and the actual display position of the hands, and correcting the display based on the result, is therefore needed when such information is displayed.

An arrangement that renders gear teeth only in the range of display wheel rotation on a display wheel to which a display hand is attached and is used in a mechanism that drives a stepping motor forward and reverse to display information in a fan-shaped range of movement is taught in Japanese Patent No. 3653746. Japanese Patent No. 3653746 teaches correcting the position of the display wheel when the control circuit is reset to the default values when the battery is replaced, for example. This correction method applies signals causing the stepping motor to move beyond the maximum range of movement to reliably reverse the display wheel to the part where there are no teeth, and then advances the display wheel from this position forward to the correct position by applying an appropriate number of signals. Unlike methods that optically detect the display wheel position, the correction method taught in Japanese Patent No. 3653746 does not require a photosensor or other optical devices, and is therefore advantageous in terms of cost while also not interfering with reducing the size or thickness.

When the display wheel is returned in the reverse direction by applying an extra number of signals, the pinion of the middle wheel located between the rotor and the display wheel runs into the part of the display wheel where there are no teeth, and rotation of the display wheel, middle wheel, and rotor stops completely at this position. However, when pulses for rotating forward from this position are output to the stepping motor, the first pulse may not reliably cause the rotor to drive forward depending on the polarity at the position where the rotor stopped, and it may not be possible to accurately correct the position of the display hand. As a result, the position of the display hand could still be offset from the correct position even though the display hand was reset to zero.

Furthermore, when the display wheel is reversed by applying extra signals, output of the excess reverse signals causes the rotor to try to rotate further in reverse. Depending on the orientation of the magnetic pole of the rotor at the position where the rotor is stopped, and the output phase of the signal, the rotor may turn one signal forward even though the output signal is a signal driving the rotor in reverse. This is another cause of the display being wrong, and correcting this problem is therefore desirable.

In addition, a stop that limits display wheel rotation by means of a part that has no teeth as described above can also cause the rotor to lock. If the rotor locks, the display wheel must be manually reversed using the crown, a button, or other external operating means, and this can be complicated.

### SUMMARY

A timepiece according to the present invention can prevent operating errors related to the position indicated by an indicating means. In addition, the display wheel can be accurately and easily set to the initial position (also referred to herein as the “zero” position) when the display wheel is reversed to a mechanical stop.

A timepiece according to a first aspect of the invention has a fan-shaped display unit including a display wheel that can rotate, a stepping motor that rotationally drives the display wheel in both forward and reverse directions, a reverse stop that limits reverse rotation of the display wheel, and an indication means that is attached to the display wheel; and a control unit that applies pulses to the stepping motor. The position of the reverse stop is set so that the orientation of one polar axis of the rotor of the stepping motor when the display wheel is stopped by the reverse stop at the reverse stop is within ±360°/(number of magnetic poles of rotor*2) from the static stable position of the polar axis. After stopping at the reverse stop, the polarity of the first pulse applied to the stepping motor by the control unit is constant.

By setting the position of the reverse stop so that the orientation of the rotor (the orientation of one polar axis of the rotor) when at the reverse stop is within a prescribed angle of rotation range to one static stable position, a pulse of a specific polarity corresponding to this one static stable position can reliably cause the rotor to rotate forward. Because the rotor thus always turns when a single pulse is applied after meeting the reverse stop, the polarity of the first pulse applied after the reverse stop is always applied in the same direction. This enables automatically and accurately adjusting the position of the indication means. More specifically, the display hand can be accurately and easily set to the initial (zero) position.

Preferably, the control unit of this timepiece executes a reset process causing a stop against the reverse stop by applying reverse signals to the stepping motor.

This aspect of the invention enables resetting the position of the indication means automatically instead of manually because the control unit executes a reset process causing the rotor to reverse and stop at the reverse stop, and the first pulse applied in a prescribed direction after the reverse stop reliably causes the rotor to turn.

In a timepiece according to another aspect of the invention the control unit applies to the stepping motor more reverse signals than required to stop at the reverse stop in the reset process, and the zeroed position of the indication means is set to the position indicated when one or more forward pulses is applied to the stepping motor after stopping at the reverse stop.

With this aspect of the invention the zeroed position of the indication means is not determined after the reset process when the forward signal (forward pulse) has not been applied, and the position indicated by the indication means after one or more forward signals is applied after the reset process is the zeroed position of the indication means.

The position indicated by the indication means immediately after contacting the reverse stop cannot be used as the zero position because the reverse stop prevents the rotor from rotating during the reset process and the position of the reverse stop also varies.

The display wheel can also conceivably rotate forward the amount of one signal as a result of applying a prescribed number of reverse signals that is greater than or equal to the number of signals needed to turn the rotor to the reverse stop. More specifically, if the number of applied reverse signals is one more than the number sufficient to reach the reverse stop, the display wheel will rotate forward one signal. When the next reverse signal is then applied from this position, the display wheel will again rotate in reverse to the reverse stop, and the display wheel will thereafter oscillate between the position rotated one signal forward and the reverse stop position as subsequent reverse signals are applied.

In other words, when noise or other factor causes the position indicated by the indication means to shift, the graduation from which the indication means reverses is unknown and the position indicated by the indication means after the reset process will not be constant even if the number of reverse signals applied in the reset process is some prescribed number.

The invention sets the position to which the rotor rotates forward when one or more forward signals is applied after going to the reverse stop as the zero position, and the indication means can therefore be reliably set to the initial position on the scale when the indication means is zeroed after the reset process. More specifically, if at least one forward pulse is applied after contacting the reverse stop, whether the rotor is driven or not driven depends on the orientation of the polar axis of the rotor when the pulse is applied, and the indication means therefore points to zero on the scale. The indication means can then be moved referenced to the correct initial position, and the indication means can be prevented from displaying wrong information.

In a timepiece according to another aspect of the invention the polarity of the last pulse applied in the reset process is the reverse of the polarity of the first pulse applied after the reverse stop.

As described above the orientation of the rotor after the reset process (reverse stop process) is not necessarily always the same. In order to zero the indication means, it is therefore necessary to change the polarity of the pulses applied to zero the indication means according to the orientation of the rotor after the reset process.

The inventors therefore focused on the polarity of the last pulse applied in the reset process and made the new discovery that the position of the rotor after the reset process will be constant if the position of the reverse stop is within a prescribed angular range to the rotor and the polarity of the last pulse applied in the reset process is opposite the polarity of the first pulse applied after the rotor goes to the reverse stop. This prescribed angular range for a two-pole rotor is on the reverse side of one static stable position before the other static stable position and within ±90° of the one static stable position. That is, after the last pulse is applied in the reset process, the rotor returns to the one static stable position.

This aspect of the invention can thus even more easily and accurately zero the indication means because the last pulse of the polarity described above in the reset process results in the indication means pointing to a constant position. More specifically, because the orientation of the polar axis of the rotor directly after going to the reverse stop is uniform and the polarity of the last pulse in the reset process is defined based on the position of the reverse stop, the indication means can be reliably zeroed to the initial position of the scale without a control means, for example, switching the polarity of the pulse for zeroing the display. More specifically, the control unit can completely automatically reset the indication means.

In a timepiece according to another aspect of the invention the fan-shaped display unit has a forward stop that limits forward rotation of the display wheel, the rotor is a two-pole rotor, and the position of the forward stop is set so that the orientation of the polar axis of the rotor when the display wheel is stopped by the forward stop at the forward stop is outside a range of ±30° from the dynamic stable position.

The forward stop and the reverse stop limit rotation of the display wheel to an angle of rotation less than 360°.

This arrangement can be achieved by adjusting the relative positions of the rotor polarity, the rotor pinion, and the display wheel.

The invention can prevent the rotor from locking after going to the forward stop. More specifically, the rotor can be reliably driven by applying a reverse signal after going to the forward stop. This can prevent display errors related to the hand position. It is therefore not necessary to operate the crown or a button to release a locked rotor, and ease of use is improved.

In addition to the effect achieved from positioning the reverse stop and the effect of setting the zero position of the indication means, setting the position of the forward stop according to this aspect of the invention affords the effect of preventing locking at the forward stop side.

More specifically, the invention can accurately set the zero position of the indication means referenced to the reverse stop and can prevent locking at the forward stop, and can thereby greatly improve reliability and automate correcting the indicated position.

Further preferably, the control unit in the timepiece according to the invention regularly runs the reset process.

This aspect of the invention improves convenience because the display position of the indication means is automatically corrected regularly, such as once a day.

Further preferably, the timepiece according to another aspect of the invention also has a detection unit for detecting an external magnetic field, and the control unit runs the reset process based on the detection result returned by the detection unit.

This aspect of the invention can correct the position of the indication means being shifted by external magnetic fields.

The timing of the reset process can be as desired any time after an external field is detected, such as when the external field strength drops to less than a prescribed reference level after an external field that is greater than or equal to the reference level is detected, or when a prescribed time has passed after the external field is detected.

Further preferably, the timepiece of the invention also has a capacitance device, and the fan-shaped display unit displays a remaining operating time based on at least one of the charge stored in the capacitance device and the cumulative charge to the capacitance device.

Whether the displayed remaining operating time (which indicates how long the timepiece can operate on the stored charge) is correct is difficult to determine from outside of the timepiece. Accurately correcting the display position of the indication means is therefore desirable, and the invention is particularly suited to such applications.

Yet further preferably, the timepiece of the invention also has a power generating device.

The power generating device can be an electromagnetic converter that converts mechanical energy from the rotation of a rotary pendulum to electrical energy, or a solar generator that converts light such as sunlight to electrical energy.

A timepiece that has such a power generating device in principle never requires replacing the battery, thus does not require a system reset because a battery is replaced, and reduces the need for the user to set the indication means. Because the invention accurately corrects the display position of the indication means as described above, the invention is particularly useful when applied in such timepieces.

By applying this aspect of the invention that does not require a system reset in the above described arrangement having a control unit that regularly or irregularly runs a reset process, the significant effect of assuring the opportunity to correct the display position of the indication means can be achieved.

Yet further preferably, the power generation state of the power generating device is displayed on the fan-shaped display unit.

Whether the displayed power generation state is accurate or not is difficult to determine from the outside of the timepiece. Accurately correcting the display position of the indication means is therefore desirable, and the invention is particularly suited to such applications.

Further preferably, the timepiece of the invention also has a capacitance device; a power generating device; and a display switching control unit for changing the display of the fan-shaped display unit to a remaining operating time based on at least one of the power stored in the capacitance device and the cumulative charge to the capacitance device, or the power generation state of the power generating device. When the display switching control unit changes the display between the remaining operating time and the power generation state, the control unit executes the reset process at least when changing from the power generation display to the remaining operating time display.

This aspect of the invention runs the reset process when the display mode changes, and can therefore increase the opportunities for correcting the display position of the indication means.

Noise from the power generator can cause the display position of the indication means to shift when power is being generated, and running the reset process to correct the display position when switching the display from the power generation mode to the remaining operating time is therefore particularly useful.

The “static stable position” as used herein means a state in which a magnetic field for driving the rotor is not produced in the coil block of the stepping motor, that is, the position of the rotor when the rotor is stopped when a magnetic field is not applied.

In a timepiece according to another preferred aspect of the invention at least one of the forward stop unit and the reverse stop unit comprises an eccentric stud including a stud part and an outside part that is eccentric to the stud part, and a part of the display wheel that stops against the outside part.

By rotating the orientation of the outside part of the eccentric stud and then securing the stud part to the base plate, for example, when the position of the outside part to the stud part is desirably adjusted, the position of the stop can be adjusted. Because the position of the stop can thus be adjusted, the rotor, display wheel, and other parts can be easily assembled so that the polar orientation of the rotor at the stop is within the prescribed angular range.

Further preferably the rotor is a two-pole rotor.

The foregoing equation ±360°/(number of magnetic poles of rotor*2) of the invention allows setting the position of the reverse stop within a wide range of ±90° (that is, less than or equal to 180°) from the static stable position, and designing the reverse stop and assembling the rotor and display wheel are thus easy.

A timepiece according to another aspect of the invention has a fan-shaped display unit including a display wheel that can rotate, a stepping motor that rotationally drives the display wheel in both forward and reverse directions, a reverse stop that limits reverse rotation of the display wheel, and an indication means that is attached to the display wheel; and a control unit that applies pulses to the stepping motor. The control unit executes a reset process that causes a stop against the reverse stop by applying reverse signals to the stepping motor, and applies to the stepping motor more reverse signals than are needed to cause a reverse stop when executing the reset process; and the zeroed position of the indication means is set to the position indicated when one or more forward pulses is applied to the stepping motor after stopping at the reverse stop.

By setting position to which the rotor turns forward when one or more pulses is applied after going to the reverse stop as the initial position of the display, the indication means can be reliably set to the initial position when zeroing the indication means after the reset process. Because the zero position is set to the position to which the rotor turns when at least one pulse is applied after stopping at the stop, or the zero position is set to a position further forward from this position, the indication means can always be positioned to the correct zero position and display errors can be prevented.

The invention prevents operating errors related to the position indicated by an indicating means.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a timepiece according to a preferred embodiment of the invention.

FIG. 2 shows the stopped position at the reverse rotation side.

FIG. 3 describes the orientation of the rotor when at the stop position in FIG. 2.

FIG. 4 shows the position after the stopping at the reverse side.

FIG. 5 describes the positioning range of the stop where the first forward signal can cause the rotor to turn.

FIG. 6 describes the movement of the rotor when the reverse signal is output.

FIG. 7 shows the stopped position at the forward rotation side.

FIG. 8 describes the orientation of the rotor when at the stop position in FIG. 7.

FIG. 9 shows the position after the stopping at the forward side.

FIG. 10 describes the movement of the rotor when a signal is output after the stop.

FIG. 11 describes the position of the stop where the rotor locks.

FIG. 12 describes a stop according to a variation of the invention.

FIG. 13 describes a stop according to another variation of the invention.

### DESCRIPTION OF THE PREFERRED EMBODIMENTS

Preferred embodiments of the present invention are described below with reference to the accompanying figures.

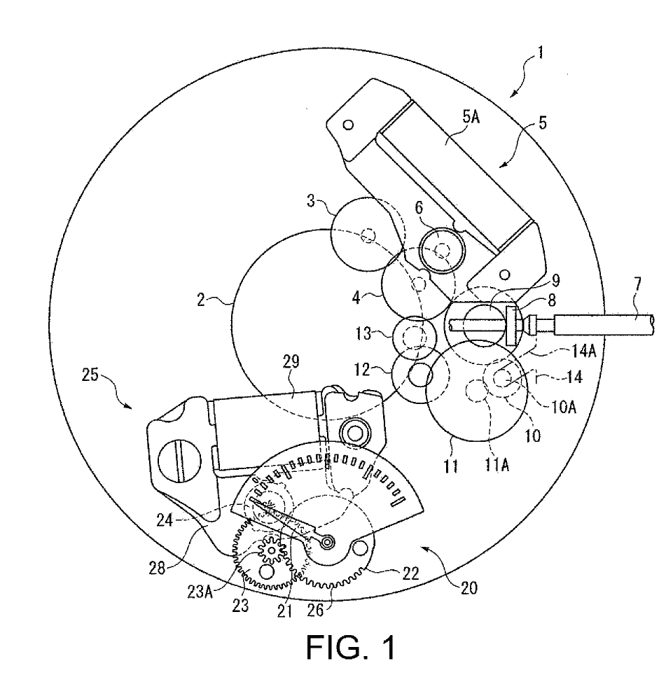

FIG. 1 is a schematic plan view of a timepiece 1 according to this embodiment of the invention. This timepiece 1 is an electronic timepiece with a power generator, and has a rotary pendulum wheel 2 that rotates in unison with a rotary pendulum not shown. Rotation of the rotary pendulum wheel 2 is transferred to a pair of switching wheels 3 and 4, and the rotation is transferred from the one switching wheel 3 to the rotor 6 of a generating device 5. The pair of switching wheels 3 and 4 is an arrangement having a ratchet wheel not shown so that the rotor 6 always turns in one direction irrespective of the direction of rotary pendulum rotation.

The generating device 5 is an electromagnetic converter, and the induction voltage produced by the coil 5A when the rotor 6 rotates is commutated by a synchronous commutation circuit not shown using a transistor. The commutated charge is accumulated in a secondary cell that is used as a capacitance device not shown, and the charge accumulated in the secondary cell is used to drive the control circuit of the circuit block, the stepping motor that drives the movement including the hour hand and minute hand, and the stepping motor 25 for the fan-shaped display unit 20 described below. Note that the stepping motor for the movement is the same as the stepping motor used in common electronic timepieces and detailed description of this stepping motor in the figures and below is therefore omitted.

In a timepiece 1 according to this embodiment of the invention the rotor 6 can be turned by the rotary pendulum or by winding the stem to produce power. More specifically, the timepiece 1 has a winding pinion 8 that turns when the stem 7 is wound, rotation of the winding pinion 8 is transferred through a crown wheel 9 to a rocker wheel 10, rotation of the rocker wheel 10 is transferred to a first manual winding transfer wheel 11, and rotation of the first manual winding transfer wheel 11 is transferred to the switching wheel 3 through a second manual winding transfer wheel 12 and a third manual winding transfer wheel 13.

The rocker wheel 10 meshes with the pinion 11A of the first manual winding transfer wheel 11 only when the stem 7 turns in one direction. More specifically, there is a slot 14A in the bridge 14 to which the rocker wheel 10 is attached, and the support shaft 10A of the rocker wheel 10 is fit to slide freely in this slot 14A. In the arrangement shown in FIG. 1, therefore, when the stem is wound so that the crown wheel 9 turns clockwise, the rocker wheel 10 turns counterclockwise and moves toward the center of the first manual winding transfer wheel 11, and meshes with the pinion 11A. When the first manual winding transfer wheel 11 is driven from the switching wheel 3 side and turns counterclockwise, however, the rocker wheel 10 separates from the pinion 11A while rotating clockwise, and therefore disengages the first manual winding transfer wheel 11. This arrangement thus prevents transferring rotation of the rotary pendulum to the stem 7.

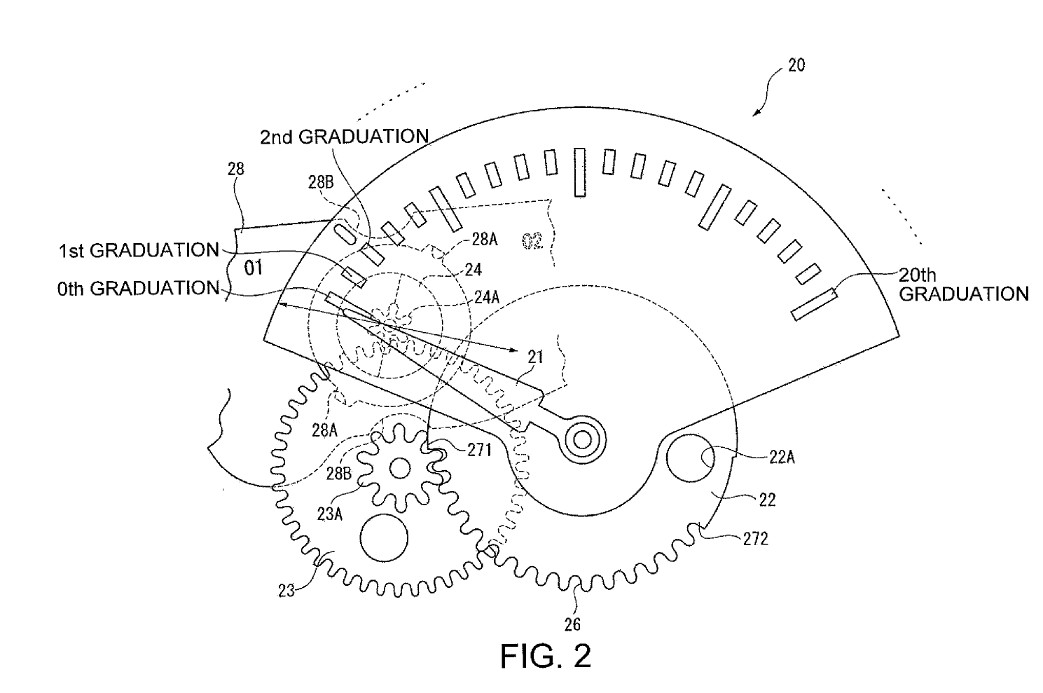

As shown enlarged in FIG. 2, the timepiece 1 according to this embodiment of the invention also has a fan-shaped display unit 20 for displaying the remaining operating time, which indicates how long the movement of the timepiece 1 can operate based on the cumulative charge in the secondary cell calculated from power generation by the generating device 5, or the power generation state of the generating device 5. The fan-shaped display unit 20 thus functions as both a duration meter and a power generation meter, and can switch between displaying the remaining operating time of the movement and the power generation state of the generating device 5.

The remaining operating time does not need to be displayed based on the cumulative charge as in this embodiment of the invention, and can be based on detecting the voltage of the secondary cell as the cumulative charge, or the remaining operating time can be displayed based on both the cumulative charge and the voltage.

When the fan-shaped display unit 20 functions as a duration meter, for example, and the scale of the fan-shaped display unit 20 is divided into 20 increments as in this embodiment of the invention, the range from the 0th to the 2nd graduation is the standby position (that is, outside the range of the assured remaining operating time) of the display hand 21 that is used as the indication means. The second graduation is the zero (0) or initial position of the display hand 21 (where zero is indicated on the display), and the range from the 2nd graduation to the 10th graduation indicates that a charge equivalent to a remaining operating time of one day is assured with each graduation equivalent to a unit of approximately three hours. The range from the 11th graduation to the 16th graduation indicates that a charge equivalent to a remaining operating time of days two to seven (that is, to one week) is assured, the 17th graduation indicates a remaining operating time of two weeks, the lath graduation indicates a remaining operating time of three weeks, and the 19th graduation indicates a remaining operating time of one month. When the fan-shaped display unit 20 functions as a duration meter, the 20th graduation is not used.

When the fan-shaped display unit 20 functions as a power generation meter in this embodiment of the invention, the power generation state is displayed particularly when the stem is turned to charge the battery. When the stem is wound to rotate the rotor 6 and produce power, the display hand 21 swings between the first graduation and the twentieth graduation according to the power generation state. The display hand 21 swings quickly when moving to the right as seen in FIG. 2, and the swing back to the left is slightly slower than the swing to the right. When returning to the left the display hand 21 returns to the graduation corresponding to the charge from winding the stem.

More specifically, the range from the first graduation to the twentieth graduation indicates that the battery has been charged to a remaining operating time of a maximum six hours. For example, if the user winds the stem once (actually one revolution of the crown) so that the battery is charged equivalent to a remaining operating time of one hour, the display hand 21 swings greatly to the right to indicate that the battery was charged, and the display hand 21 then returns to the fifth graduation denoting a charge of one hour. If the user then turns the stem a second time (by winding the crown again), the display hand 21 again swings greatly to the right from the fifth graduation to indicate that the battery was charged, and, assuming that this operation produced a charge equivalent to a total remaining operating time of two hours, the display hand 21 then returns to the eighth graduation. As the battery is thus charged by the power generation operation, the position to which the display hand 21 returns moves to the right, and after charging to a remaining operating time of a maximum six hours, the display hand 21 stops swinging and is held at the twentieth graduation.

The display hand 21 of this fan-shaped display unit 20 is attached to a display wheel 22, the display wheel 22 meshes with the pinion 23A of an intermediate wheel 23, and the intermediate wheel 23 meshes with the rotor 24 of the stepping motor 25. The angle of rotation of the display wheel 22 when one signal is output to the stepping motor 25 is 6°, which is the same as the angle of rotation of the seconds wheel in a conventional electronic timepiece.

The timepiece 1 also has an IC device not shown that calculates the cumulative charge based on power generation by the generating device 5. When the fan-shaped display unit 20 functions as a duration meter, the IC outputs a pulse signal based on this cumulative charge to the stepping motor 25 and stops and holds the display hand 21 at the graduation corresponding to the remaining operating time.

The IC (not shown in the figure) used in the timepiece 1 in this embodiment of the invention renders both a control unit that applies pulses to the stepping motor 25, and a display switching control unit that changes the display of the fan-shaped display unit 20. The invention is not so limited, however, and this control unit and display control unit can be rendered in discrete IC devices. Note that the IC device in this embodiment of the invention also provides control other than applying pulses to the stepping motor 25 and changing the display mode of the fan-shaped display unit 20.

When the fan-shaped display unit 20 functions as a power generation meter, the IC device applies a signal corresponding to the power output of the generating device 5 to the stepping motor 25. More specifically, when the display hand 21 is moved to the right to indicate power generation, the IC outputs a signal at a high frequency of 64 steps/second to move the rotor 24 quickly forward, and when returning the display hand 21 to the left, the IC outputs a signal at a lower frequency of 32 steps/second to drive the rotor 24 in reverse. This operation produces a pulsing action that looks like an analog meter and a display that appears to flow, and can thereby make the movement of the display hand 21 to appear linked to winding the stem.

Particularly when the fan-shaped display unit 20 is made to function as a power generation meter, the return movement of the display hand 21, that is, reversing the 24, is achieved by continuously outputting a reverse signal (composed of plural pulses) from the IC to the stepping motor 25. To drive the rotor 24 forward, a forward signal identical to the signal applied to the stepping motor for moving the second hand is output according to the generated power output. The signal frequency for reverse rotation and forward rotation is as described above.

In the fan-shaped display unit 20 shown in FIG. 2 the display wheel 22 does not have teeth formed around the entire circumference, and instead only has teeth formed continuously in part. The ends of the toothed part 26 of the display wheel 22 where teeth are formed render a reverse stop 271 and a forward stop 272 against which the pinion 23A of the intermediate wheel 23 stops. In FIG. 2 the pinion 23A is shown stopped against the reverse stop 271.

The rotor 24 of the stepping motor 25 used in this embodiment of the invention is a two-pole rotor that is magnetized with one north and one south pole. A pair of opposing internal notches 28A are formed radially to the inside circumference of the rotor housing hole in the stator 28 of the stepping motor 25 so that the rotor 24 is held stopped in a static stable state (static stable position) where a line through opposing north and south poles of the rotor 24 (through a pair of poles) is perpendicular to a line passing through the internal notches 28A.

A pair of external notches 28B is disposed in the outside perimeter of the stator 28 with the rotor 24 between the external notches 28B. When the coil 29 (FIG. 1) of the stepping motor 25 is energized, the line through the poles rotor 24 (denoted by the arrow in FIG. 2) becomes perpendicular to the line through these external notches 28B, and the rotor 24 is held stopped and stable in this position (dynamic stable position).

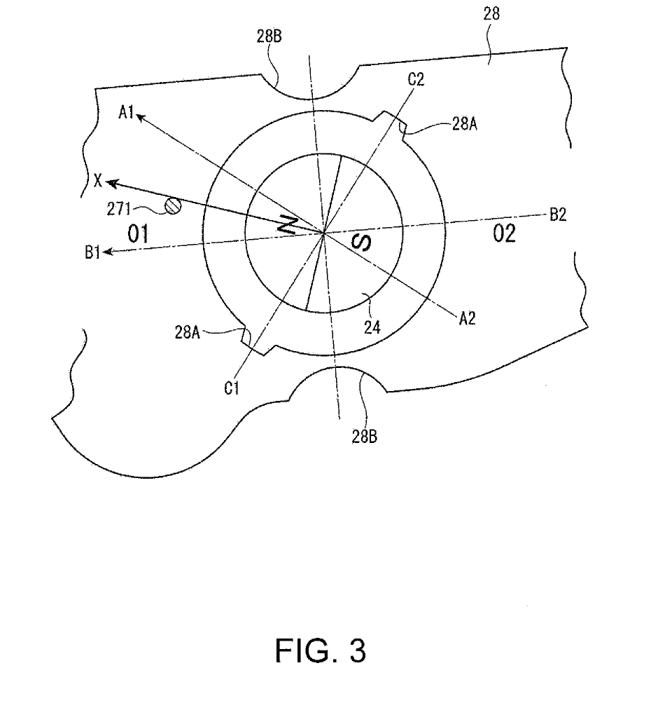

FIG. 3 schematically shows the position of the rotor 24 relative to the stopped position of the display wheel 22 in FIG. 2. Line segments through a pair of magnetic poles (north and south poles) of the rotor 24 are denoted by arrows A1, B1, and X in FIG. 3. The position of the rotor 24 in one static stable position (with the north pole and south pole in substantially the same positions shown in FIG. 3) is denoted by arrow A1. A dynamic stable position near this static stable position A1 is indicated by arrow B1. At a position substantially midway between this static stable position A1 and dynamic stable position B1, the pinion 23A of the intermediate wheel 23 stops against the reverse stop 271 of the display wheel 22 in this embodiment of the invention, and the schematic position of the reverse stop 271 is denoted in FIG. 3 by a circle. More specifically, the display wheel 22 stops when arrow X stops at the position of the reverse stop 271 denoted by a circle, and the orientation of the rotor 24 at this time is as shown in FIG. 3.

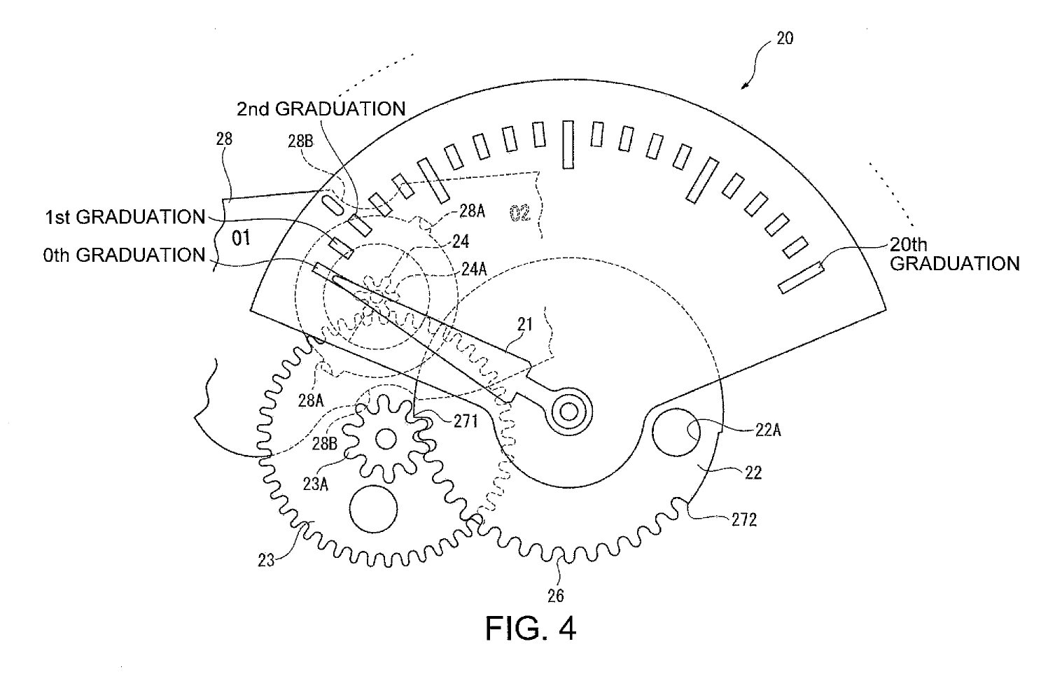

If arrow X is set where contact is made with the reverse stop 271 between arrow A1 and arrow B1 (actually the point where the pinion 23A contacts the reverse stop 271), the rotor 24 returns to the static stable position after the coil 29 is de-energized. More specifically, the rotor 24 returns to where line X overlaps line A1. The state in which the rotor 24 is stopped at the static stable position A1 is shown in FIG. 4.

As shown in FIG. 4, when the rotor 24 is at the static stable position A1, the display hand 21 points directly to the zero graduation. Conversely stated, the display hand 21 is attached to the display wheel 22 so that the display hand 21 points to the zero graduation when in this static stable position A1.

A specific method of attaching the display hand 21 is, for example, to place permanent magnets around the rotor housing hole during the assembly process so that the rotor 24 faces as shown in FIG. 3 and FIG. 4 as a result of attraction between the permanent magnets and the magnetic poles of the rotor 24 inside the rotor housing hole. The display wheel 22 is attached so that it always points in the same direction at this time. This is achieved by disposing a guide pin as a positioning pin at a specific position on a base plate not shown and passing a round hole 22A disposed in the display wheel 22 over this guide pin so that the orientation of the display wheel 22 is always the same.

This results in the rotor 24 and the display wheel 22 always being assembled in the same phase relationship, the rotor 24 and the display wheel 22 always being positioned as shown in FIG. 2 when the pinion 23A contacts the reverse stop 271, and the display hand 21 always being positioned as shown in FIG. 4 when pointing to the zero graduation of the scale.

A notch indicating the orientation of the magnetic poles is preferably rendered at one part of the rotor pinion 24A of the rotor 24 so that when assembling the rotor 24 this notch can be used as a index to confirm if the magnetic poles of the rotor 24 are facing the prescribed direction.

As shown in FIG. 4, when the rotor 24 returns to the static stable position after contacting the reverse stop and one forward signal pulse (pulse N repulsing from the north pole) is output from the 01 output side of the stator 28 as seen in the figure, the rotor 24 rotates reliably 180° in the forward rotation direction (clockwise as seen in the figure) due to the orientation of the magnetic poles of the rotor 24, and the display hand 21 moves exactly one graduation.

As shown in FIG. 3, the rotor 24 is automatically positioned at the static stable position A1 after contacting the reverse stop 271 between the static stable position (arrow A1) and the dynamic stable position (arrow B1). As a result, if the reverse stop is set in the range between the static stable position A1 and the dynamic stable position B1, the rotor 24 will always be reliably driven forward at the first signal pulse after meeting the reverse stop.

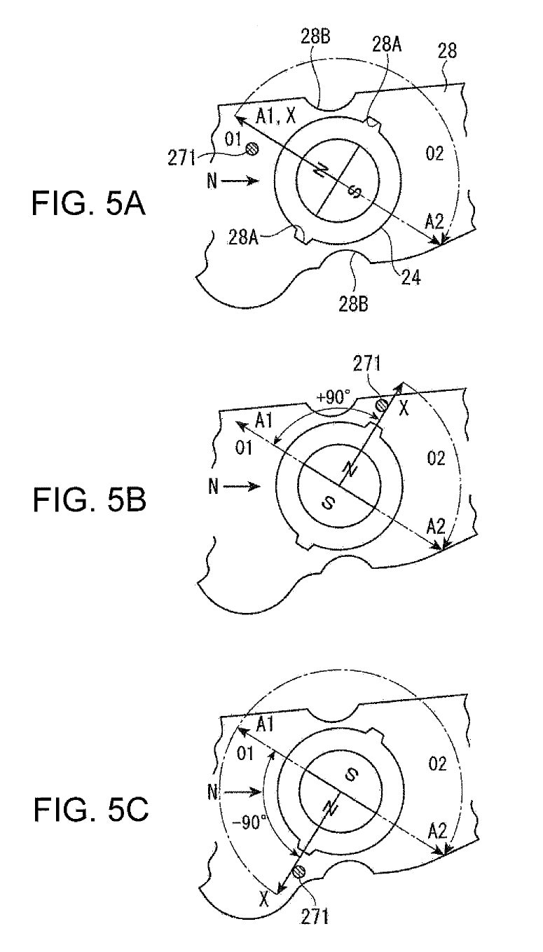

The ability to reliably drive the rotor 24 forward at the first signal pulse after stopping at the reverse rotation stop is not limited to arrangements having the location of the reverse stop between the static stable position A1 and the dynamic stable position B1 of the rotor 24. More particularly, we have confirmed that the first pulse can reliably drive the rotor forward as long as the reverse stop is within ±90° of one static stable position A1 of the rotor 24. This is further described below with reference to FIG. 5.

The rotor 24 can be reliably driven forward at the first pulse after stopping against the reverse stop as long as the position of the reverse stop is in a range of ±90° to the static stable position A1, but setting the position of the reverse stop between the static stable position A1 and the dynamic stable position B1 as in this embodiment of the invention affords more stable operation.

If the rotor 24 is not reliably driven forward by the first pulse applied, the position indicated by the display hand 21 will shift, and the fan-shaped display unit 20 will not function correctly.

FIG. 5A shows the rotor 24 positioned with its polar axis aligned with the static stable position A1 after rebounding from the reverse stop between the dynamic stable position B1 and the static stable position A1. As described above, when a pulse N that repulses with the north pole is output from the 01 side of the stator 28, the rotor 24 rotates reliably forward 180°. As a result, the display hand 21 moves one graduation from the 0th graduation to the first graduation (where “−1” is shown on the display).

In this embodiment of the invention, the rotor 24 being in the one static stable position A1 means that the north pole and the south pole of the rotor 24 are oriented as shown in FIG. 5A. When the orientation of the north pole and south pole is 180° opposite that shown in FIG. 5A, the rotor 24 is in the other static stable position A2 (see FIG. 3).

FIG. 5B shows the rotor 24 when stopped at the reverse stop when the reverse stop is shifted ±90° (90° forward) from the static stable position A1. The rotor 24 is in a neutral position at this time, and if the current supply is stopped, the rotor 24 will not return to static stable position A1 because of the relationship to the reverse stop 271. Note that the rotor 24 will not return to the static stable position A1 and operation will be the same as described below with reference to FIG. 5B whether the reverse stop position is at ±90° (the neutral position) from the static stable position A1 or at another position between the static stable position A1 and ±90°.

When one pulse N that repulses with the north pole is output from the 01 side of the stator 28 at the position shown in FIG. 5B, the rotor 24 will turn only approximately 90° forward to a position 180° from the static stable position A1, and the display hand 21 will move one graduation from the 0th graduation to the first graduation, that is, the same position shown in FIG. 5A.

Note that when the rotor 24 is stopped against the reverse stop positioned as shown in FIG. 5B the display hand 21 will point to a position approximately halfway between the 0th graduation and the first graduation.

FIG. 5C shows the rotor 24 stopped at the reverse stop when the reverse stop is shifted −90° (90° reverse) from the static stable position A1. The rotor 24 is in the neutral position opposite the neutral position shown in FIG. 5B at this time, and if the rotor is de-energized, the rotor 24 will stay stopped at this position and will not advance to the static stable position A1.

If the rotor 24 stops at a reverse stop between the dynamic stable position B1 and the neutral position on the reverse side of B1 (−90° from the static stable position A1), the rotor 24 will advance to the static stable position A1. Operation in this case will thereafter be the same as described below with reference to FIG. 5C.

When one pulse N that repulses with the north pole is output from the 01 side of the stator 28 at the position shown in FIG. 5C, the rotor 24 will immediately advance approximately 270° forward to a position 180° from the static stable position A1, and the display hand 21 will move one graduation from the 0th graduation to the first graduation as shown in FIG. 5A and FIG. 5B.

When stopped at a reverse stop positioned as shown in FIG. 5C, the display hand 21 will point to an off-scale position from the 0th graduation.

In order to reliably drive the rotor 24 forward with the first pulse that is applied after the rotor 24 returns to the reverse stop position using a two-pole rotor as in this embodiment of the invention, the reverse stop must be set within ±90° of the static stable position A1 of the rotor 24.

More specifically, the position of the reverse stop must only be a within ±360°/(number of rotor poles*2) from the static stable position A1, If using a four-pole rotor with two north poles and two south poles, for example, the reverse stop is set to a position within ±45° of the static stable position.

In addition to defining the orientation of the magnetic poles of the rotor 24, this embodiment of the invention also defines the direction of the coil winding of the coil block of the stepping motor 25. The first pulse applied after the rotor rebounds from the reverse stop will cause the rotor to turn depending on the relationship between the winding direction of the coil block, the polarity of the first output pulse after the reverse stop, and the orientation of the magnetic poles of the rotor.

Returning (resetting) the display hand 21 is described next. In order to move the display hand 21 to the right side as seen in FIG. 4 to display the power generation state when the fan-shaped display unit 20 is driven to function as a power generation meter, the IC device simply outputs to the stepping motor 25 a specific number of consecutive signals (forward signals) causing the rotor 24 to rotate in the forward direction. To return the display hand 21 to the left side, the IC device simply outputs a number of consecutive pulses (reverse signals) causing the rotor 24 to reverse. To reliably return the display hand 21 to the 0th graduation (“−2” on the scale), this embodiment of the invention applies 22 reversing pulses, that is, more pulses than is required to reset the display hand 21 from the 20th (maximum) graduation on the scale, as the reverse signal for resetting the display hand 21 regardless of where the display hand 21 is positioned.

When the stem is wound a second, third, and additional times after the stem is wound once to recharge the battery, the IC device first outputs 22 reverse signals, then outputs a number of forward signals corresponding to the power that is generated by winding the stem twice to move the display hand 21 to the right again, then again outputs 22 reverse signal pulses to return the display hand 21 to the left, and repeats this sequence. Repeating this sequence causes the movement of the display hand 21 to simulate an analog meter.

When stem winding ends and the IC device determines that it is necessary to end functioning as a power meter, the IC device outputs 22 reverse signals and then outputs a specific number of forward signals to move the display hand 21 to the graduation denoting the remaining operating time in order to switch the fan-shaped display unit 20 to the duration meter mode. In order to switch the fan-shaped display unit 20 from a power generation meter to a duration meter, the IC device in this embodiment of the invention executes a reset process that applies 22 reverse signals to the stepping motor 25 and thus causes the rotor to return to the reverse stop. In addition to when switching the fan-shaped display unit 20 from the power generation mode to the duration meter mode, the IC device also executes this reset process once a day at a regular interval (such as at 00:00).

This embodiment of the invention always outputs 22 reverse signals in the reset process even though the forward stop 272 prevents the display hand 21 from swinging farther to the positive side than the 20th graduation at the maximum scale position. As a result, the pinion 23A of the intermediate wheel 23 always stops at the reverse stop 271 at the reverse end of the display wheel 22 to which the display hand 21 is attached, and the reverse signal may continue to be output after hitting the reverse stop 271. The movement of the rotor 24 as a result of continued reverse signal output after turning to the reverse stop is described next below.

One reverse signal generally consists of a set of three pulses, a first repulsion pulse causing the rotor 24 to rotate slightly forward, an attraction pulse pulling the rotor 24 to the reverse side from this slightly forward rotated position, and a second repulsion pulse that uses the inertia of this pulling action to reverse the rotor 24 at once. The first repulsion pulse and the attraction pulse are output for a short time (32 steps/second in this embodiment of the invention), and the second repulsion pulse is output for the same time as the normal forward signal (64 steps/second in this embodiment of the invention).

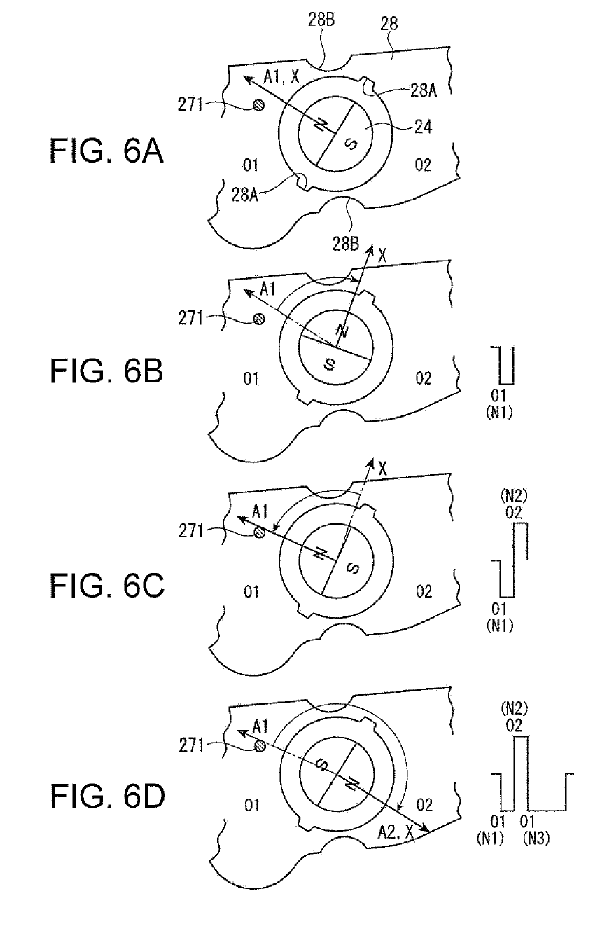

FIG. 6A shows the state after a reverse signal was output and the pinion 23A stopped at the reverse stop 271. As described above, the reverse stop is between the static stable position A1 and the dynamic stable position B1 of the rotor 24, and the state in FIG. 6A shows the rotor 24 stopped at the static stable position A1 and the display hand 21 pointing to the 0th graduation (“−2” on the display) (see FIG. 4). FIG. 6B to FIG. 5D show the change in position after the reverse signal is output continuously.

Note that the reverse signal and the forward signal are output so that the north pole of the rotor 24 is alternately repulsed from the 01 side when the north pole of the rotor 24 is facing the 01 side, and from the 02 side when the north pole of the rotor 24 is facing the 02 side.

When the rotor 24 is positioned as shown in FIG. 6A and the reverse signal is a short repulsion pulse N1 output from the 01 side, the rotor 24 rotates clockwise as shown in FIG. 6B. Because the output time of this repulsion pulse N1 is short, the rotor 24 cannot rotate 180°. An attraction pulse N2 is then output from the 02 side as shown in FIG. 6B This attraction pulse N2 causes the rotor 24 to return quickly counterclockwise. As shown in FIG. 6C, a repulsion pulse N3 is then output for the normal output time to cause the rotor 24 to rotate counterclockwise in reverse. If the reverse stop 271 is not present, the rotor 24 will rotate passed the dynamic stable position B1 at this time to the same reverse direction as when the attraction pulse N2 was applied. However, because the pinion 23A contacts the reverse stop 271 between the static stable position A1 and the dynamic stable position B1 in this embodiment of the invention, the rotor 24 cannot go beyond the dynamic stable position B1, and the repulsion pulse N3 actually causes the rotor 24 to rotate 180° forward as shown in FIG. 6D due to the reaction of the impact of the pinion 23A against the reverse stop 271.

When a reverse signal is then output from the 02 side in the state shown in FIG. 6D, the rotor 24 rotates 180° and returns to the position shown in FIG. 6A, and returns again to the position shown in FIG. 6D when a reverse signal is output from the 01 side. In other words, when the reverse signal is output continuously after reaching the reverse stop, the rotor 24 rotates from the position shown in FIG. 6A to the position shown in FIG. 6D, and then from the position shown in FIG. 6D to the position shown in FIG. 6A, and the display hand 21 therefore oscillates between the 0th graduation (“−2” on the scale) and the 1st graduation (“−1” on the scale). This action repeats until the reverse signal has been output 22 times, that is, until the reset process ends.

Because it is not known from which graduation the display hand 21 is reset, the display hand 21 points to the 0th or 1st graduation at the reset end of the scale after 22 reverse signals are output (after the reset process). As a result, if the 0th graduation is set as the zero (0) position, that is, the start of the scale, the display hand 21 may stop at the 0 position of the scale, or at the 1 position in certain cases, and if a forward signal is output to display the remaining operating time when the display hand 21 is stopped at the 1 position on the scale, the indicated remaining operating time will be one graduation too much and will not be displayed correctly. The timepiece may also stop operating in this case if the display hand 21 is pointing to “1” so that it erroneously appears that operating (duration) time is left.

This embodiment of the invention therefore sets the zero (0) position (starting position) of the scale at the second graduation. The IC device remembers whether the 22nd reverse signal was output from the 01 side or the 02 side, and knows that the display hand 21 is at the 1st graduation after the signal is output from the 01 side, and that the display hand 21 is at the 0th graduation after the signal is output from the 02 side.

The system is therefore arranged so that if the 22nd signal was output from the 02 side, two forward signals for resetting the display hand 21 to zero are output, including one from the 01 side and one from the 02 side, before outputting the forward signal to display the remaining operating time. More specifically, the IC device regulates this system operation. This operation causes the display hand 21 to stop at the second graduation, that is, the starting (0) position on the scale.

The system is also arranged to output only one forward signal for zeroing the display hand from the 02 side if the 22nd signal was output from the 01 side so that the display hand 21 is again zeroed to the 2nd graduation.

Because the 2nd graduation is set as the zero position for the display hand 21, this embodiment of the invention can consistently correctly set the display hand 21 referenced to the true zero position even if outputting extra reverse signals causes the display hand 21 to rotate one signal forward because a forward signal is always applied to zero the display hand 21 to the second graduation before outputting forward signals to set the display hand 21 from this zero position to the graduation indicating the correct remaining operating time or power generation status. Incorrectly displaying the remaining operating time, which is an example of internal timepiece 1 information, can thus be reliably prevented.

As shown in FIG. 3, in this embodiment of the invention the relative positions of the polar axis of the rotor 24 and the reverse stop 271 (FIG. 2) are set so that the position of the reverse stop (reference number 271 in FIG. 3) is midway between the static stable position A1 and the dynamic stable position B1. In this embodiment of the invention and when the polar axis of the rotor 24 at the reverse stop is within ±90° of the static stable position A1 as shown in FIG. 5B and FIG. 5C, the first pulse applied after contact with the reverse stop can reliably cause the rotor 24 to rotate forward. Because the polar orientation of the rotor 24 is thus defined so that the first pulse after the reverse stop causes the rotor 24 to turn, the display hand 21 can be reliably zeroed by making the graduation to which the display hand 21 points when one or more (two in this embodiment) signals are applied after contacting the reverse stop the zero position of the display hand 21.

What happens if the polar axis of the rotor 24 at the reverse stop is outside the range of +90° to the one static stable position A1 is described next.

Referring to FIG. 3, when the reverse stop position is set between the neutral position C2 (+90° from the static stable position A1) and the dynamic stable position B2, for example, the rotor 24 returns to the other static stable position A2 after hitting the reverse stop and then being de-energized, and is held in this position (not shown in the figure). When a reverse signal is then output from the 01 side in this state, the pinion 23A simply stops at the reverse stop 271 and the same state is held. If the reverse signal is output from the 02 side, force causing the rotor 24 to turn does not work and the rotor 24 remains in the same position. Whether a pulse is output from the 01 side or a pulse is output from the 02 side after contact with the reverse stop, the rotor 24 thus does not rotate and locks up.

This locking problem does not occur in this aspect of the invention, however, because the reverse stop is set in a range of ±90° from the static stable position A1.

What happens when the reverse stop is disposed between the neutral position C1 (−90° from the static stable position A1) and the other static stable position A2 is described next.

When the rotor stops at the reverse stop in this position and the rotor is then de-energized, the rotor 24 has already passed the neutral position C1 and therefore tries to rotate to the other static stable position but cannot because the rotor has already turned to the reverse stop and therefore remains against the stop. If a reverse signal is output again from this position, the rotor remains held at the reverse stop when the reverse signal is output from the 01 side, but if the signal is output from the 02 side, the rotor 24 rotates to the reverse side and returns to the one static stable position A1. When the reverse stop is thus positioned the rotor 24 stops at a position passed −90° from the one static stable position A1, and the first forward signal will not necessarily cause the rotor 24 to rotate forward.

The last pulse that is output in the reset process in which the reverse signal is output continuously is described next.

The following tables show for different reverse stop locations the last output pulse before meeting the reverse stop and the position indicated by the display hand 21 when the first to third extra reverse signals are output in the reset process. Note that because twenty-two reverse signals are output continuously in the reset process from the 01 side in this embodiment of the invention, the pulse that is output immediately before striking the reverse stop in the reset process is output from the 02 side.

In each of the tables “0” denotes the 0th graduation, “1” denotes the first graduation, and “−1” denotes an off-scale position on the negative side of the 0th graduation.

TABLE 1
1-1 Reverse stop between first static stable position A1 and dynamic
stable position B1

| Reset process | Pulse output side and indicated position |
|---|---|
| Pulse before | 02 |
| reverse stop | |

| | | |
|---|---|---|
| 1st | (01) | +1 |
| 2nd | (02) | 0 |
| 3rd | (01) | +1 |

TABLE 2
1-2 Reverse stop between dynamic stable position B1 and neutral
position C1

| Reset process | Pulse output side and indicated position |
|---|---|
| Pulse before | 02 |
| reverse stop | |

| | | |
|---|---|---|
| 1st | (01) | 0 |
| 2nd | (02) | 0 |
| 3rd | (01) | 0 |

TABLE 3
1-3 Reverse stop between neutral position C1 and other static stable
position A2

| Reset process | Pulse output side and indicated position |
|---|---|
| Pulse before | 02 |
| reverse stop | |

| | | |
|---|---|---|
| 1st | (01) | −1 |
| 2nd | (02) | 0 |
| 3rd | (01) | −1 |

As shown in Tables 1-1 to Table 1-3, the position indicated by the display hand 21 after the reset process differs according to the location of the reverse stop, but if the last pulse applied in the reset process is from the 02 side, the display hand 21 will be positioned to the 0th graduation. More specifically, the polarity of the last pulse (output from the 02 side) applied in the reset process is the reverse of the polarity of the first pulse (output from the 01 side) applied after the reverse stop, and the position of the rotor after the reset process is therefore constant.

Therefore, as shown in the following tables, the position indicated by the display hand 21 can be set to the zero position (the second graduation) by applying the last pulse in the reset process from the 02 side and then applying two forward pulses from the 01 side after the reset process (see the right side in each table). The result of outputting the first pulse after the reset process from the 02 side when the last pulse in the reset process is output from the 01 side is also shown in each table (see the left side in each table) for comparison with the result of outputting the last pulse in the reset process from the 02 side.

TABLE 4
2-1 Reverse stop between static stable position and dynamic stable
position

| Reverse -> | | |
|---|---|---|
| forward | Pulse output side and indicated position | |
| Last pulse | 01 (+1) | 02 (0) |

| | | | | |
|---|---|---|---|---|
| Forward | (02) | +2 | (01) | +1 |
| pulse 1 | | | | |
| Forward | (01) | +3 | (02) | +2 |
| pulse 2 | | | | |
| Forward | (02) | +4 | (01) | +3 |
| pulse 3 | | | | |

TABLE 5
2-2 Reverse stop between dynamic stable position and neutral position

| Reverse -> | | |
|---|---|---|
| forward | Pulse output side and indicated position | |
| Last pulse | 01 (0) | 02 (0) |

| | | | | |
|---|---|---|---|---|
| Forward | (02) | 0 | (01) | +1 |
| pulse 1 | | | | |
| Forward | (01) | +1 | (02) | +2 |
| pulse 2 | | | | |
| Forward | (02) | +2 | (01) | +3 |
| pulse 3 | | | | |

TABLE 6
2-3 Reverse stop between neutral position and other static stable
position

| Reverse -> | | |
|---|---|---|
| forward | Pulse output side and indicated position | |
| Last pulse | 01 (−1) | 02 (0) |

| | | | | |
|---|---|---|---|---|
| Forward | (02) | 0 | (01) | +1 |
| pulse 1 | | | | |
| Forward | (01) | +1 | (02) | +2 |
| pulse 2 | | | | |
| Forward | (02) | +2 | (01) | +3 |
| pulse 3 | | | | |

When the reverse stop is located on the reverse side of the one static stable position A1 between the static stable position A1 and the other static stable position A2, this embodiment of the invention outputs the last pulse in the reset process from the 02 side and then outputs a forward pulse from the 01 side, and thereby reliably and accurately positions the display hand 21 to the zero position of the scale.

More specifically, because the orientation of the polar axis of the rotor 24 directly after going to the reverse stop is uniform and the polarity of the last pulse in the reset process is defined based on the location of the reverse stop 271, the display hand 21 can be reliably zeroed to the initial position of the scale without detecting, for example, the position indicated by the display hand 21. A benefit of this aspect of the invention is that there is no need to switch the output direction of the pulse when zeroing the display. More specifically, the display hand 21 can be automatically zeroed by simply outputting a pulse in a single direction.

The polarity of the last pulse output in the reset process can be determined according to the direction of the first reverse signal output in the reset process and the number of reverse signals. The first reverse signal in the reset process in this embodiment of the invention is output from the 01 side, and the number of reverse signals is therefore even.

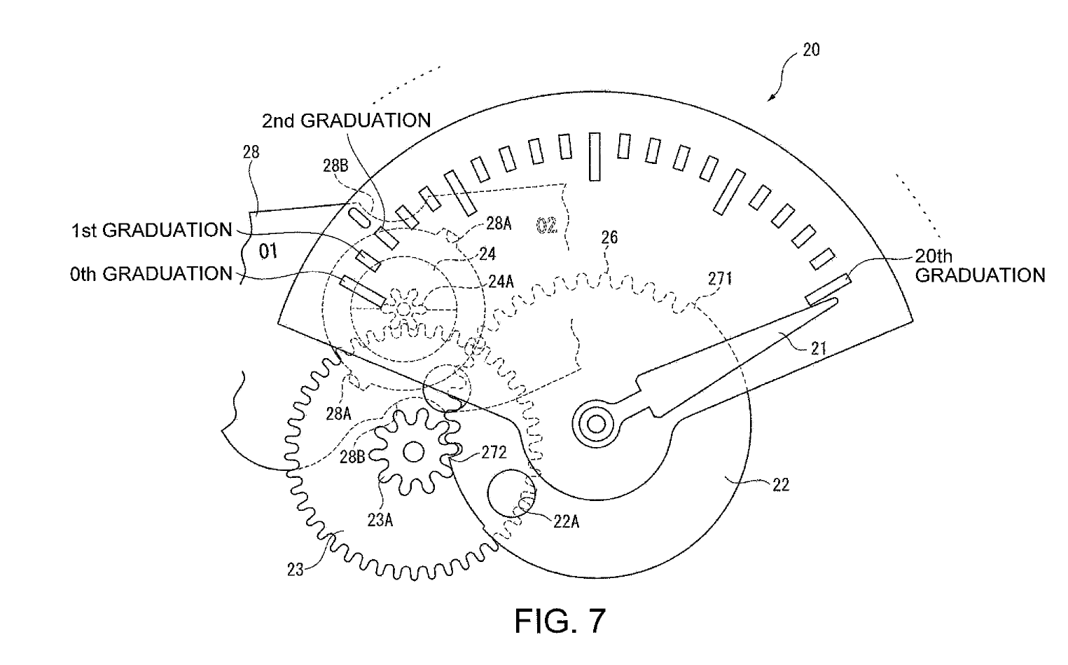

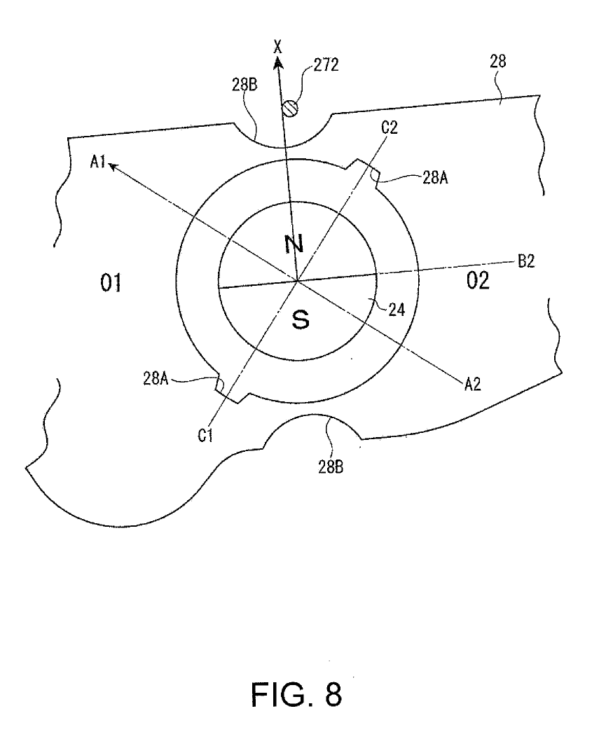

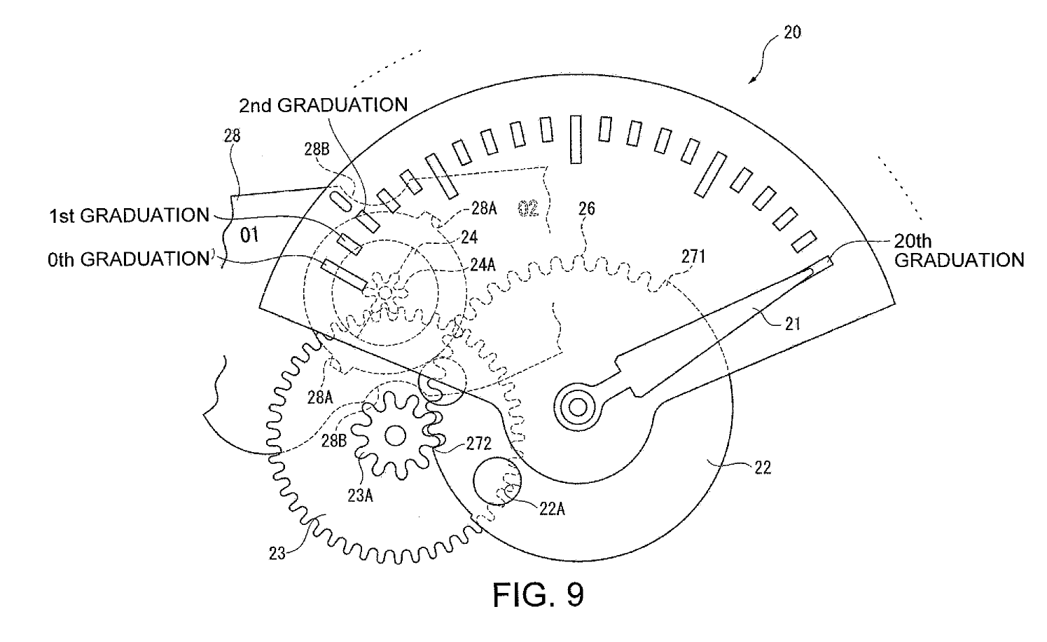

The stop on the forward rotation side is described next. FIG. 7 shows the pinion 23A stopped against the forward stop 272 on the forward rotation end of the display wheel 22. The display hand 21 is positioned off-scale beyond the 20th graduation and the polar axis of the rotor 24 is oriented as indicated by arrow X in FIG. 8 at this time. When positioned as shown in FIG. 8 the rotor 24 is between the static stable position (arrow A1 in the figure) and the neutral position C2 on the forward side of static stable position A1 (+90° from static stable position A1), and is stopped against the forward stop. The rotor 24 only stops against the forward stop when the display hand 21 swings passed the 20th graduation. The display hand 21 may swing beyond the 20th graduation due to a movement error when the reset operation is repeated in the power meter mode, or when the position of the display hand 21 is shifted by an external magnetic field or shock from being dropped, for example. The rotor 24 can thus hit the forward stop when the fan-shaped display unit 20 functions as a power meter or as a duration meter. When the rotor 24 stops at the forward stop as shown in FIG. 8 and is then de-energized, the rotor 24 returns to the static stable position A1 and the display hand 21 points directly at the 20th graduation as shown in FIG. 9.

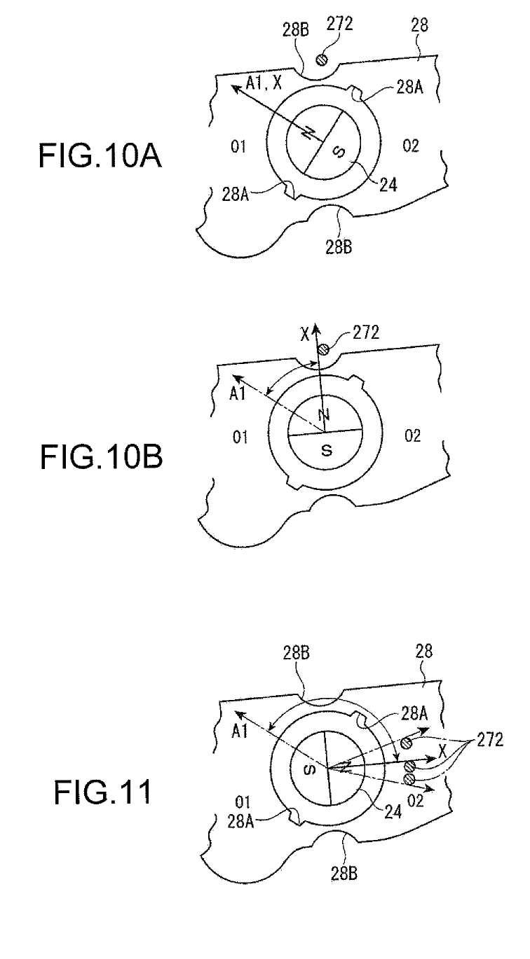

When the forward stop is thus set between the static stable position A1 of the rotor 24 and the forward neutral position C2, the rotor 24 returns to the static stable position A1 after being de-energized and tends to remain at this position as shown in FIG. 9 and FIG. 10A. However, if a forward signal is then output from the 01 side, for example, the rotor 24 again goes to the forward stop as shown in FIG. 10B and cannot pass the neutral position C2 (FIG. 8), and therefore returns to the static stable position A1. If the signal is output from the 02 side, there is no repulsion and no rotational force therefore acts on the rotor 24, and the rotor 24 therefore again remains in the static stable position.

Note that the position of the forward stop 272 is shown schematically by the shaded circles in FIG. 10 and FIG. 11.

When a reverse signal is output from the 01 side when the rotor 24 is positioned as shown in FIG. 10B, the first short repulsion pulse N1 causes the rotor 24 to rotate, strike the forward stop, and reverse precisely one graduation. If the pulse is output from the 02 side, however, the rotor 24 will not rotate and reverse at the first short repulsion pulse, and the rotor 24 only reverses when the next reverse signal is output from the 01 side. The rotor 24 not reversing when the first pulse is output from the 02 side is not a problem, however, because the reset process that continuously outputs the reverse signal outputs more reverse signals that is needed by the actual scale (22 signals in this aspect of the invention) in order to simply return the display hand 21 to zero.

Although not shown in the figures, if the forward stop is positioned between the neutral position C2 of the rotor 24 (+90° from the static stable position A1) and before the dynamic stable position B2 (near the position 110° forward from the position shown in FIG. 10A) the rotor 24 tries to advance to the static stable position A2 on the 02 side when de-energized after hitting the forward stop because the forward stop is located on the forward side passed the neutral position C2. However, because the pinion 23A is held against the forward stop 272, the display hand 21 stops and is held at a position passed the 20th graduation.

If the forward signal is output continuously from this position, the rotor 24 will not move away from the forward stop position regardless of whether the forward signal is output form the 01 side or the 02 side. In addition, the rotor 24 will reverse correctly one graduation when the reverse signal is output whether the reverse signal is output from the 01 side or the 02 side. In other words, the reset process executes with no problem.

As shown in FIG. 11, however, it the forward stop 272 is set within approximately ±30° of the dynamic stable position B2, not only is the position held after hitting the forward stop, but the rotor 24 does not move whether the forward signal is output from the 01 side or the 02 side. The rotor 24 also does not move whether the reverse signal is output from the 01 or the 02 side. The rotor 24 is thus firmly locked and the display hand 21 cannot be reset. It is therefore necessary to avoid positioning the forward stop in this range.

This embodiment of the invention therefore positions the forward stop 272 so that the polar axis of the rotor 24 at the forward stop is outside the range of ±30° of the dynamic stable position. This arrangement prevents the rotor 24 from locking.

If the orientation of the polar axis of the rotor 24 at the forward stop is rotated 180° from the orientation in this embodiment of the invention, the position of the forward stop must still be set so that the polar axis of the rotor 24 is outside the range of ±30° of the dynamic stable position.

The reset process is controlled in this embodiment of the invention so that the display hand 21 returns from the 20th graduation side of the scale to the 0th graduation. A reset process that returns the display hand 21 from the 0th graduation side to the 20th graduation side is also conceivable. In this case the stop at the 20th graduation side of the scale is configured as the reverse stop and the stop at the 0th graduation side is configured as the forward stop.

This arrangement differs only in which end of the scale is used as the home position. More specifically, in an arrangement that is reversed from this embodiment of the invention, the position of the stop at the 20th graduation side of the scale is within ±90° of the static stable position, and the position of the stop on the 0th graduation side is set outside the range of ±30° from the dynamic stable position.

The invention is not limited to the embodiment described above and can be modified and improved in many ways without departing from the scope of the accompanying claims.

For example, the foregoing embodiment of the invention has a generating device 5 that converts mechanical energy from the rotation of a rotary pendulum to electrical energy, but the power generating means used in the present invention is not so limited and could be, for example, a solar generator.

The indicating means of the invention is also not limited to a display hand 21, and could be a display wheel for displaying astrological signs, for example.

The initial or zero position of the scale on the fan-shaped display unit 20 is the second graduation in the foregoing embodiment of the invention, but the initial position could be the first graduation when continuous reverse signals cause the indicator to oscillate between the 0th graduation and the first graduation, for example. More specifically, the initial (zero) position can be set to the position that is indicated when one or more forward signals are applied from the 0th graduation that is indicated at the stop.

This embodiment of the invention has a reverse stop 271 and a forward stop 272 at opposite ends of the toothed part 26 of the display wheel 22 so that rotation of the display wheel 22 stops when the pinion 23A of the intermediate wheel 23 stops at the reverse stop 271 and forward stop 272. The arrangement of the stop is not so limited, however. For example, an oblong hole can be rendered in the toothed portion of the display wheel and a pin that passes through this oblong hole can be disposed to the base plate so that the display wheel stops when the pin hits an end of the oblong hole. The reverse stop and the forward stop parts of the present invention are rendered in this arrangement by the pin and where the oblong hole contacts the pin.

Alternatively, a protrusion that rotates in unison with the display wheel can be provided so that the protrusion contacts a riser disposed to the base plate. In this arrangement the stop is rendered by the protrusion and the riser.

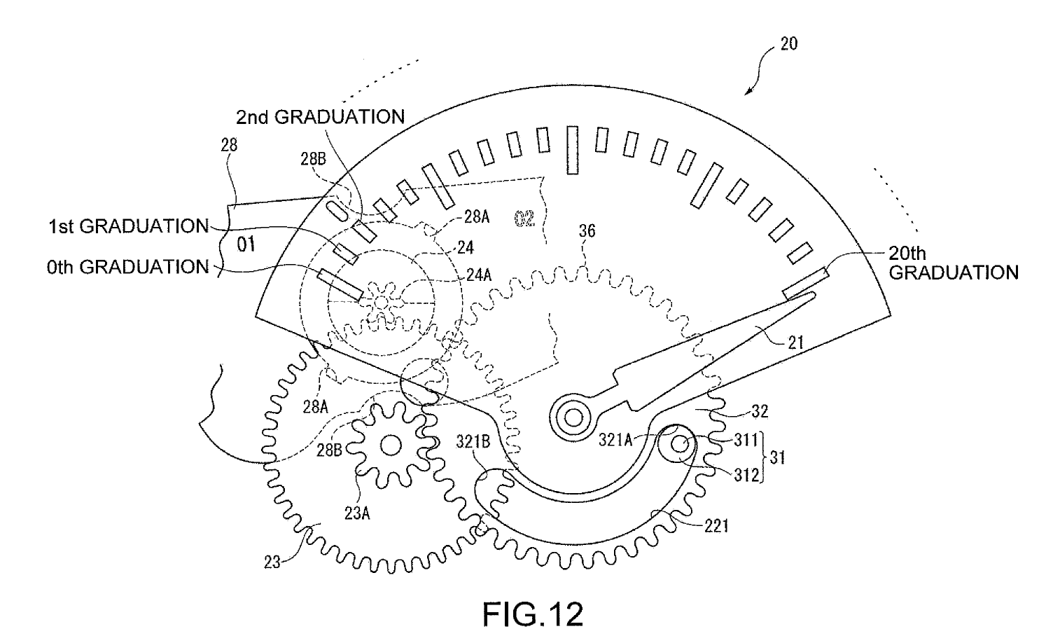

The arrangement of a stop that differs from the stops in the foregoing embodiment of the invention is described next with reference to FIG. 12. This aspect of the invention enables adjusting the position of the stop by means of an eccentric stud 31.

The eccentric stud 31 includes a stud part 311 that is disposed to the base plate, for example, and an outside part 312 that is eccentric to the stud part 311. The outside part 312 passes through an oblong hole 321 disposed in the display wheel 32. The outside part 312 contacts the end portion 321A of the oblong hole 321 when the display wheel 32 rotates forward, and contacts the end portion 321B of the oblong hole 321 when the display wheel 32 rotates in reverse. The eccentric stud 31 and end portion 321A thus render a forward stop, and the eccentric stud 31 and end portion 321B render a reverse stop.

This display wheel 32 differs from the display wheel 22 in the previous embodiment (FIG. 7) in that the display wheel 32 has teeth 36 around the entire circumference. This embodiment of the invention thus enables using a general purpose display wheel 32 instead of a display wheel 22 that has a toothed part 26 only in part as in the previous embodiment.

When assembling this aspect of the invention the position of the stop can be adjusted by rotating the orientation of the outside part 312 of the eccentric stud 31 to adjust the position of the outside part 312 to the stud part 311 and then fastening the stud part 311 to the base plate, for example. By thus enabling adjusting the position of the stop, the rotor 24, the display wheel 32, and other components can be easily assembled so that the orientation of the polar axis of the rotor 24 at the forward stop is outside the range of ±30° to the dynamic stable position.

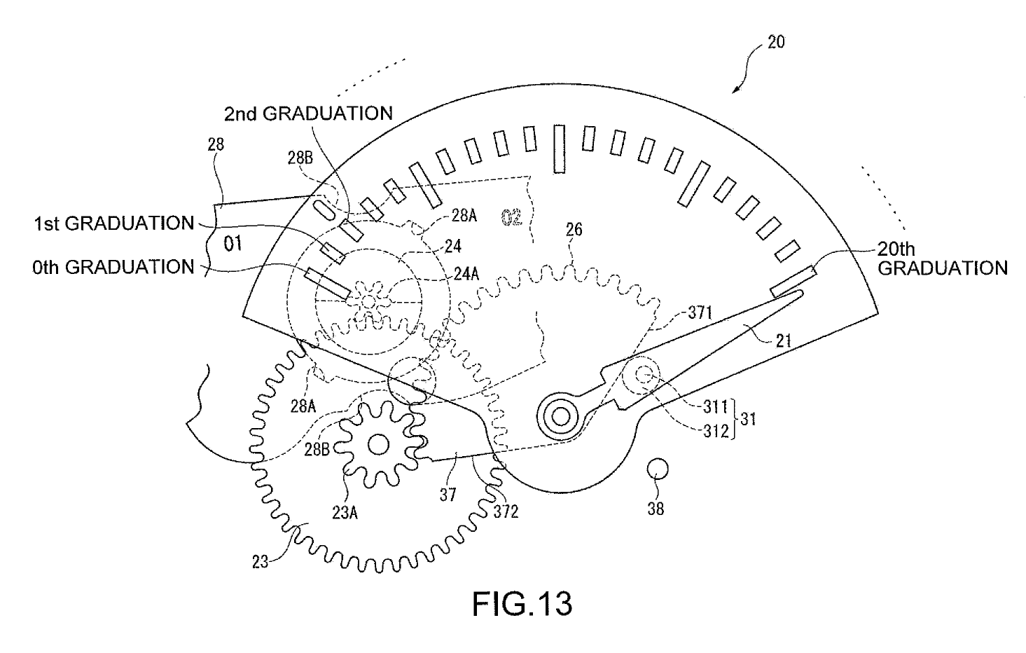

The arrangement of another stop is shown in FIG. 13. As in the arrangement shown in FIG. 12, this arrangement enables adjusting the position of the stop by means of an eccentric stud 31.

This embodiment of the invention uses a fan-shaped display wheel 37, and the outside part 312 of the eccentric stud 31 described above contacts an edge portion 371 of the fan-shaped display wheel 37. More specifically, the edge portion 371 of the fan-shaped display wheel 37 and the eccentric stud 31 render a forward stop. A pin 38 and the edge portion 372 of the fan-shaped display wheel 37 on the opposite side as the edge portion 371 render a reverse stop.

This arrangement also enables adjusting the position of the stop during assembly by rotating the orientation of the outside part 312 of the eccentric stud 31 to adjust the position of the outside part 312 to the stud part 311 and then securing the stud part 311 to the base plate, for example. As a result, the rotor 24, the display wheel 22, and other parts can be easily assembled so that the polar axis of the rotor 24 is oriented in a prescribed angular range or is outside of a prescribed angular range when the rotor 24 is stopped at the stop.

The position of the reverse stop can be similarly adjusted by rendering the pin 38 in the same way as the eccentric stud 31.

In this embodiment of the invention the coil block of the stepping motor for driving the hour and minute hands, for example, is preferably used as an external magnetic field detection means to detect external magnetic fields and execute the reset process based on the detected result. This enables compensating for external magnetic fields shifting the position of the display hand 21. In this arrangement the reset process can be executed when the strength of the detected magnetic field exceeds a prescribed reference level.

Three reset processes, that is, the reset process executed regularly such as once a day, the reset process that is executed when switching the display between the power meter and duration meter modes, and this reset process that is triggered by external magnetic field detection, can be used in combination. Alternatively, the reset process can be run only at regular intervals, the reset process can be run only when changing the display mode, the reset process can be run only when triggered by external magnetic field detection, or the reset process can be run in only any two of these situations.

The fan-shaped display unit 20 in the foregoing embodiments of the invention is used as both a duration meter and a power meter, but the invention is not so limited and a fan-shaped display unit that displays the remaining operating time and a fan-shaped display unit that displays the power generation state can be separately provided.

An integrated stator 28 that has internal notches 28A and external notches 28B formed in the stator 28 is used in the foregoing embodiments of the invention, but the invention is not so limited. The stator of the stepping motor can be disposed in two eccentrically disposed parts, for example.

The fan-shaped display unit of the invention is suitable for displaying such internal timepiece information as the power generation state of the power generator and the remaining capacity of a storage cell, but the information displayed on the fan-shaped display unit of the invention is not so limited. More particularly, the displayed information could include the calendar, weekday, or month, for example.

The present invention can be advantageously used in a timepiece that has a fan-shaped display unit driven by a stepping motor.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

The entire disclosure of Japanese Patent Application Nos: 2006-276156, filed Oct. 10, 2006, 2006-276157, filed Oct. 10, 2006, 2007-177196, filed Jul. 5, 2007 and 2007-177197, filed Jul. 5, 2007 are expressly incorporated by reference herein.

What is claimed is:

1. A timepiece comprising:
a fan-shaped display unit including a display wheel that can rotate, a stepping motor that rotationally drives the display wheel in both forward and reverse directions, a reverse stop that limits reverse rotation of the display wheel, and an indication means that is attached to the display wheel; and
a control unit that applies pulses to the stepping motor;
wherein the position of the reverse stop is set so that the orientation of one polar axis of the rotor of the stepping motor when the display wheel is stopped by the reverse stop at the reverse stop is within ±360°/(number of magnetic poles of rotor*2) from the static stable position of the polar axis, and
after stopping at the reverse stop, the polarity of the first pulse applied to the stepping motor by the control unit is constant.

2. The timepiece described in claim 1, wherein:
the control unit executes a reset process causing a stop against the reverse stop by applying reverse signals to the stepping motor.

3. The timepiece described in claim 2, wherein:
the control unit applies to the stepping motor more reverse signals than required to stop at the reverse stop in the reset process; and
the zeroed position of the indication means is set to the position indicated when one or more forward pulses is applied to the stepping motor after stopping at the reverse stop.

4. The timepiece described in claim 3, wherein:
the polarity of the last pulse applied in the reset process is the reverse of the polarity of the first pulse applied after the reverse stop.

5. The timepiece described in claim 1, wherein:
the fan-shaped display unit has a forward stop that limits forward rotation of the display wheel;
the rotor is a two-pole rotor; and
the position of the forward stop is set so that the orientation of the polar axis of the rotor when the display wheel is stopped by the forward stop at the forward stop is outside a range of ±30° from the dynamic stable position.

6. The timepiece described in claim 2, wherein the control unit regularly runs the reset process.

7. The timepiece described in claim 2, further comprising:
a detection unit for detecting an external magnetic field;
wherein the control unit runs the reset process based on the detection result returned by the detection unit.

8. The timepiece described in claim 1, further comprising:
a capacitance device;
wherein the fan-shaped display unit displays a remaining operating time based on at least one of the charge stored in the capacitance device and the cumulative charge to the capacitance device.

9. The timepiece described in claim 1, further comprising a power generating device.

10. The timepiece described in claim 9, wherein the fan-shaped display unit displays the power generation state of the power generating device.

11. The timepiece described in claim 2, further comprising:
a capacitance device;
a power generating device; and
a display switching control unit for changing the display of the fan-shaped display unit to a remaining operating time based on at least one of the power stored in the capacitance device and the cumulative charge to the capacitance device, or the power generation state of the power generating device;
wherein when the display switching control unit changes the display between the remaining operating time and the power generation state, the control unit executes the reset process at least when changing from the power generation display to the remaining operating time display.

12. The timepiece described in claim 1, wherein at least one of the forward stop unit and the reverse stop unit comprises an eccentric stud including a stud part and an outside part that is eccentric to the stud part, and a part of the display wheel that stops against the outside part.

13. The timepiece described in claim 1, wherein the rotor is a two-pole rotor.

14. A timepiece comprising:
a fan-shaped display unit including a display wheel that can rotate, a stepping motor that rotationally drives the display wheel in both forward and reverse directions, a reverse stop that limits reverse rotation of the display wheel, and an indication means that is attached to the display wheel; and
a control unit that applies pulses to the stepping motor;
wherein the control unit executes a reset process that causes a stop against the reverse stop by applying reverse signals to the stepping motor, and applies to the stepping motor more reverse signals than are needed to cause a reverse stop when executing the reset process; and
the zeroed position of the indication means is set to the position indicated when one or more forward pulses is applied to the stepping motor after stopping at the reverse stop.
